(19) United States
(12) Patent Application Publication
(10) Pub. No.: US 2025/0283698 A1
(43) Pub. Date: Sep. 11, 2025

(54) SYSTEMS AND METHODS FOR ACTIVE ASSAILANT RESPONSE

(71) Applicant: ShotHawk LLC, Peoria, IL (US)

(72) Inventors: Brandon Ross Johnson, Washington, IL (US); Nathan Grove, Mapleton, IL (US); Ohm Vyas, Geneva, IL (US); Ved Vyas, Geneva, IL (US)

(73) Assignee: ShotHawk LLC, Peoria, IL (US)

(21) Appl. No.: 19/075,155

(22) Filed: Mar. 10, 2025

Related U.S. Application Data
(60) Provisional application No. 63/563,574, filed on Mar. 11, 2024.

(51) Int. Cl. F41H 11/00; G06F 21/31; G06K 7/14; G07C 9/00

(52) U.S. Cl. CPC F41H 11/00; G06F 21/31; G07C 9/00182; G06K 7/1404

(57) ABSTRACT

An active assailant response system comprising a set of response units configured to deploy a nonlethal deterrent and including a first response unit arranged in a first zone of an environment and a second response unit arranged in a second zone of the environment; a set of detection units configured to identify one or more active assailants within the environment and including a first detection unit arranged in the first zone of the environment and a second detection unit arranged in the second zone of the environment; and a computer in communication with the set of response units and being configured to determine that at least one active assailant is present within one of the zones based on signals received from the set of detection units, and activate the set of response units in response to the at least one active assailant being present within one zones.

### PRIORITY CLAIM

This application claims priority to and all the benefits of U.S. Provisional Patent Application No. 63/563,574, filed on Mar. 11, 2024, the entire contents of which are hereby incorporated by reference.

### TECHNICAL FIELD

The present disclosure generally relates to systems and methods for responding to an active assailant.

### BACKGROUND

Known active assailant responding devices and systems rely on human piloting of a response unit. This requires a launch sequence to enable the human pilot to be in control of the device on scene. Conventional launch sequences use valuable time that could instead be used to save lives. Other systems exist to put either nonlethals or a lethal weapon in the hand of an individual through a series of pre-installed boxes in an environment, such as a building. However, none of these systems can autonomously respond to the active assailant or operate within a mapped environment. As such, there is a need in the art for an active assailant response system that provides quick and autonomous response to active assailant situations, such as in an environment where the system has been pre-installed ahead of time.

### SUMMARY

An active assailant response system is provided. The active assailant response system includes a set of response units, a set of detection units, and a computer in communication with the set of response units and the set of detection units. The set of response units is configured to deploy a nonlethal deterrent and includes a first response unit arranged in a first zone of an environment and a second response unit arranged in a second zone of the environment. The set of detection units is configured to identify one or more active assailants within the environment and includes a first detection unit arranged in the first zone of the environment and a second detection unit arranged in the second zone of the environment. The computer is configured to determine that at least one active assailant is present within one of the first and second zones based on signals received from the set of detection units and activate the set of response units in response to the at least one active assailant being present within one of the first and second zones.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 includes a perspective view of an active assailant response system according to one implementation.

FIG. 2 illustrates an arrangement of response unit relative to various zones of a school according to one implementation.

FIG. 3 includes a block diagram illustrating various components of the active assailant response system of FIG. 1.

FIGS. 4A-4C depict various perspective views of a turret unit according to one implementation.

FIGS. 5A-5F depict various perspective views of a turret unit according to another implementation.

FIGS. 6A-6D depict various perspective views of a rail traversal unit according to one implementation.

FIGS. 7A-7D depict various perspective views of an aerial traversal unit according to one implementation.

FIGS. 8A-8D depict various perspective views of a cable traversal unit according to one implementation.

FIGS. 9A-9D depict various perspective views of a wheeled traversal unit according to one implementation.

FIG. 10 includes a block diagram showing connections between components of a response unit according to one implementation.

FIG. 11 includes a perspective view of a physical switch according to one implementation.

FIG. 12 depicts a graphical user interface of the activate assailant response system of FIG. 1 according to one implementation.

FIG. 13 includes a flowchart describing a method of controlling an active assailant response system according to a first implementation.

FIG. 14 includes a flowchart describing a method of controlling an active assailant response system according to a second implementation.

FIG. 15 includes a flowchart describing a method of controlling a response unit according to one implementation.

FIG. 16 includes a flowchart describing a method of updating response units according to one implementation.

FIG. 17 shows a first arrangement of response unit disposed in various zones of a small school.

FIG. 18 shows a second arrangement of response unit disposed in various zones of a large school.

### DETAILED DESCRIPTION

Referring to the Figures, wherein like numerals indicate like or corresponding parts throughout the several views, an active assailant response system is shown throughout.

### I. System Overview

The embodiments of the invention, as disclosed herein, offer optimal architecture and operation of an autonomous active assailant response system. The preferred implementations are illustrated in the context of autonomous active shooter response. A person of ordinary skill in the art will readily appreciate that the systems and methods disclosed herein may also be applicable to a number of other contexts wherein an active shooter, mass shooter, gunman, or other type of active assailant may exist as a threat to other individuals.

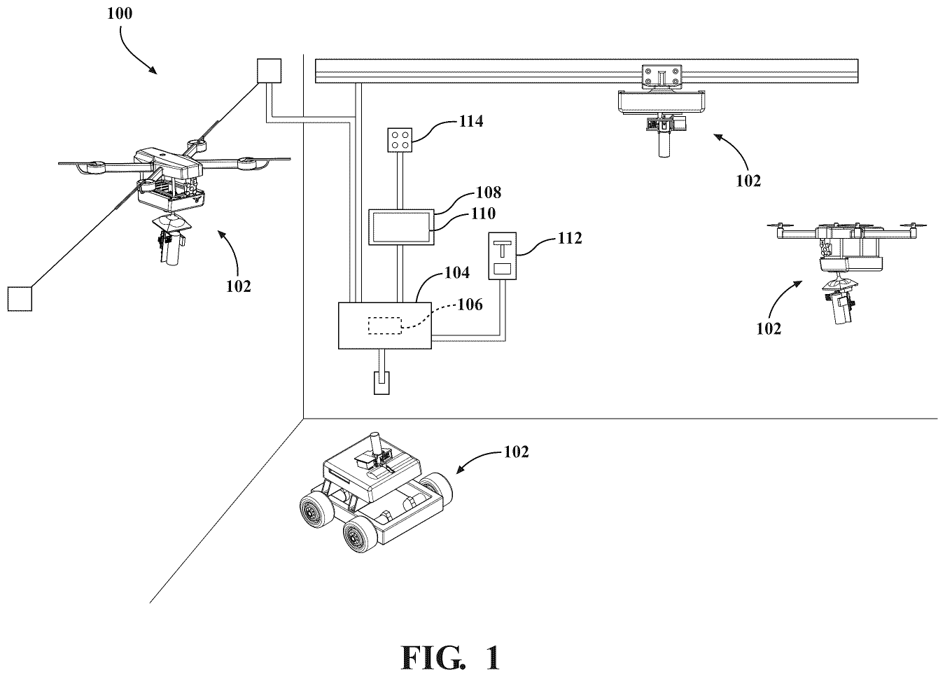

Referring to FIG. 1, a perspective view of an active assailant response system 100 according to one implementation is shown. The system 100 may include at least one response unit 102 configured to deploy a nonlethal deterrent in response to an active assailant being detected/identified within an environment. The environment may include a building, a courtyard, an outdoor location, or a combination thereof. In the figures, the environment is shown as schools of various sizes, but the system 100 may be disposed within the other aforementioned types of environments. As shown, the response unit(s) 102 may traverse the environment via rail, cable, air, and/or ground. In some implementations, response units 102 of multiple types may be provided to increase the efficacy of the system 100, like by reducing the chance that limitations of one type of traversal limits the ability of the system 100 to neutralize an active assailant. In order to control the unit(s) 102, the system 100 may further include a response computer 104. Further, the system 100 may include an interface hub 106 configured to facilitate communication between the response computer 104 and the response unit(s) 102. Even further, the system 100 may include an input interface 108 configured to display a graphical user interface (GUI) 110, such as a display configured to received touch input, so that the system 100 may receive commands and other types of inputs from a user.

The system 100 may be activated in various manners. As described in further detail below, the system 100 may be activated autonomously, such as in response to the detection of an active assailant by sensor(s) coupled to one or more of the units 102 or by an external detection unit 114 disposed in an environment (e.g., a school) equipped with the system 100. The sensor(s) and/or external detection unit 114 may include a camera, a LIDAR device, Additionally or alternatively, the system 100 may include a physical switch that, when actuated, causes the system 100 to activate.

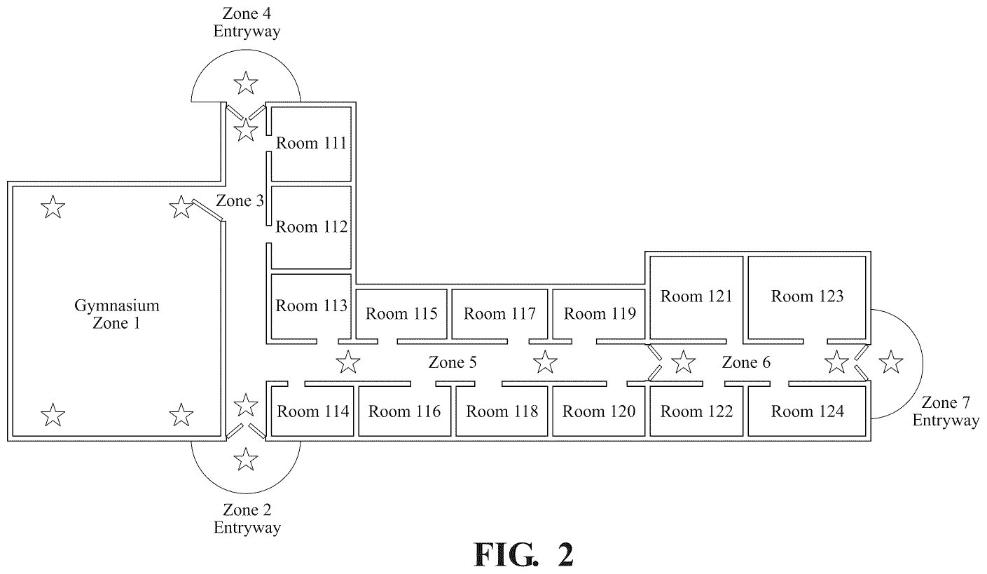

Although FIG. 1 depicts the elements of the active assailant response system 100, the figure only includes one “zone” of the system 100. In some implementations, only one such zone may be provided. In other implementations, however, the system 100 may include multiple zones 100 as the environment in which the system 100 is disposed may be larger or include different sections that are at least somewhat separated from one another. For example, as shown in FIG. 2, the active assailant response system 100 may be disposed in a school to combat school shootings. In the illustrated example, the school includes Zones 1-7, and the response units 102 of the system 100 are disposed in each of the zones as shown by the star icons. Alternatively, the system 100 may be configured to protect some of the zones rather than all of the zones. Further, the system 100 may be configured to corral the active assailant towards and into one of the zones, such as Zone 1. This allows the system 100 to move the active assailant towards zones in which there are no bystanders, and away from zones that do include bystanders. To this end, although not shown, the system 100 may be in communication with door mechanism of doors that separate the zones or parts of one zone, and system 100 may send a signal to the door mechanism to close and/or lock the door separating the first and second zones in response to the active assailant having been corralled into one of the first and second zones of the environment.

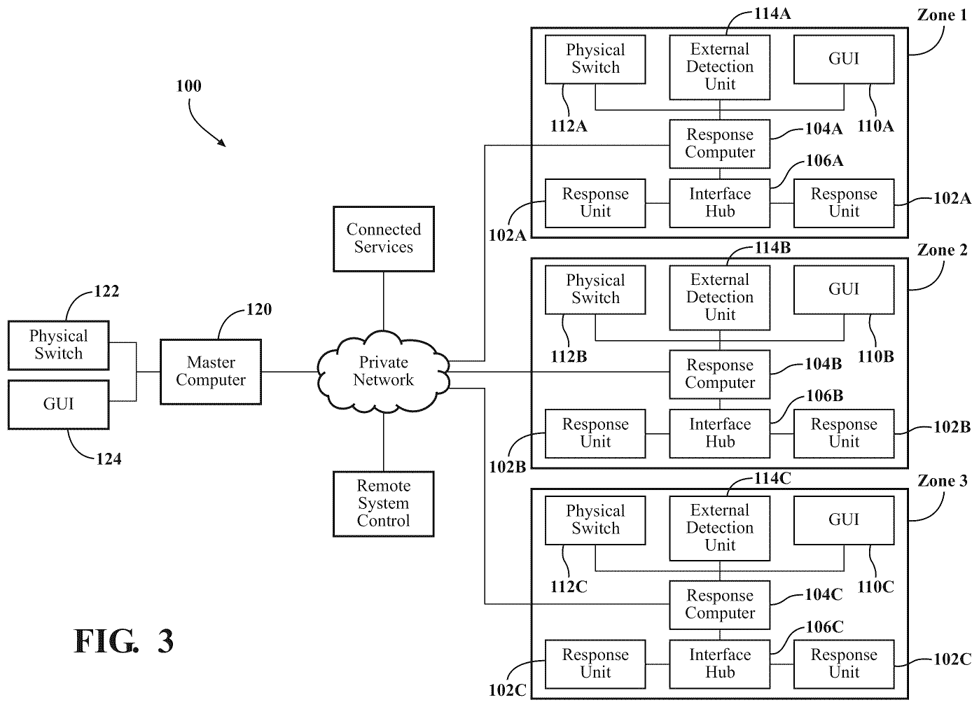

Referring to FIG. 3, a block diagram illustrating various components of an implementation of the active assailant response system 100 configured to protect multiple zones of a building environment is shown. In this implementation, there are three zones, Zones 1-3, but it will be appreciated that the ideas discussed in reference to this figure may also be applied to any number of zones.

Starting with the specific zones, each of Zones 1-3 is shown to include the components of the system 100 shown in FIG. 1. More specifically, Zone 1 may include a first response unit 102A (or multiple units 102A), a first response computer 104A, a first interface hub 106A, means for displaying a first GUI 110A, a first physical switch 112, and a first external detection unit 114. Corresponding elements may be disposed in Zone 2 and Zone 3, such as second and third response units 102B, 102C (or multiple units 102B, 102C in each zone), second and third response computers 104B, 104C, second and third interface hubs 106B, 106C, means for displaying second and third GUIs 110B, 110C, second and third physical switches 112B, 112C, and/or second and third external detection units 114B, 114C. Each of the zone-specific components, such as the first response computer 104A, are labeled with a letter (A-C) to indicate that it is zone-specific. That said, it should be understood that the elements labeled with a letter are similar in structure and configuration to those labeled without a letter. For example, the first response computer 104A may be like the response computer 104 shown and described in reference to FIG. 1.

As for the active assailant response system 100 as a whole, the system 100 may include means for controlling each zone. In the illustrated implementation, the system 100 includes a master computer 120 configured to communicate with the response computers 104A, 104B, 104C of each zone over a private network. Additionally, the system 100 may include a physical switch 122 and/or GUI 124 in direct communication with the master computer 120, and these elements 122, 124 may be used to control the master computer 120 (and the components of each zone by extension). Further, at least one of the computers 104A, 104B, 104C, 120 may include a memory device (not shown), and the memory device may include a map of the environment. The map of the environment may be used for various purposes, such as to corral the active assailant as described in more detail below.

The response units 102 include a turret unit configured to identify, track, and subdue an active assailant, and may further include a traversal unit configured to move the turret unit. If movement of the response unit 102 is not desired or not necessary, the response unit 102 may include only a turret unit fixably coupled to a wall or other surface. Additionally or alternatively, the response unit 102 may include a traversal unit where it is necessary or desired for the response unit 102 to move.

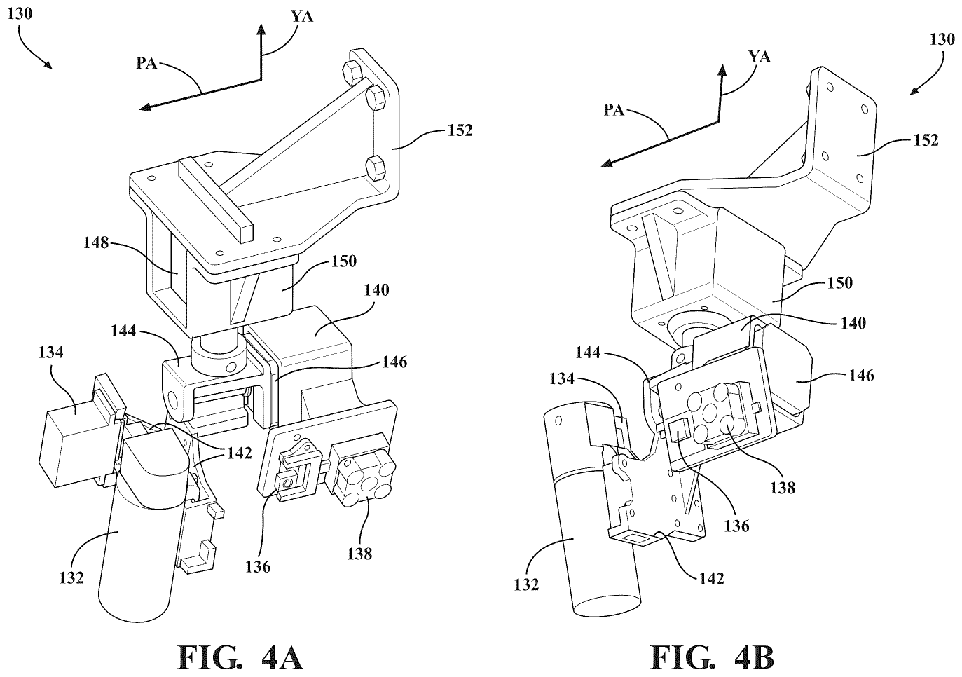

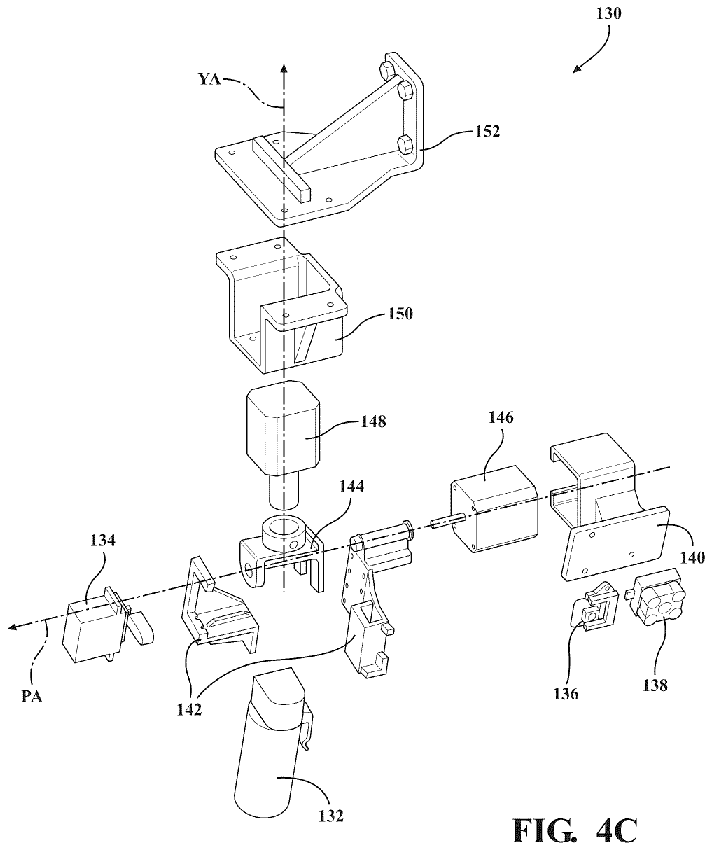

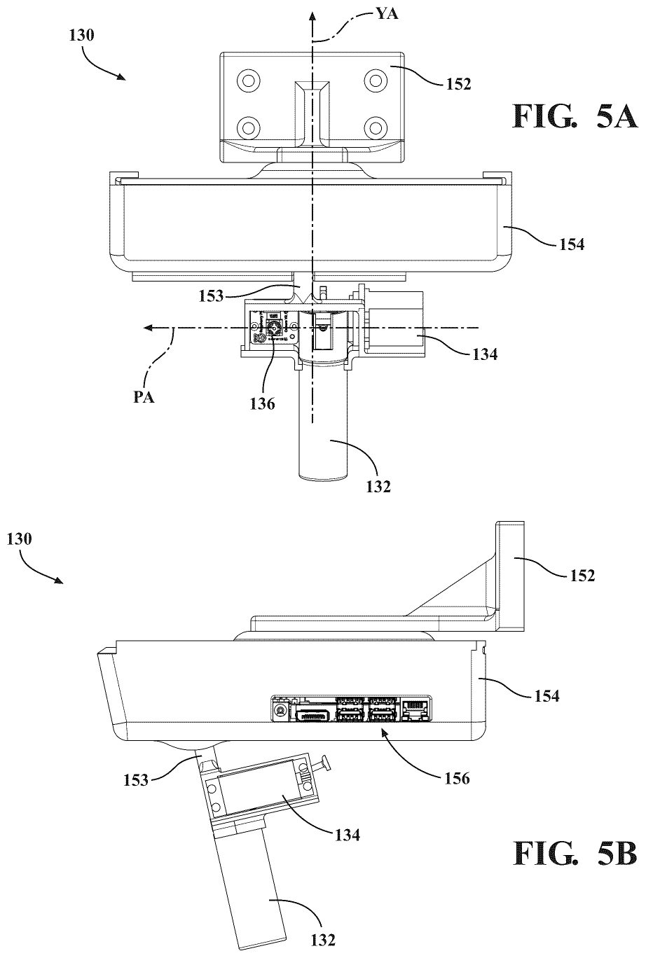

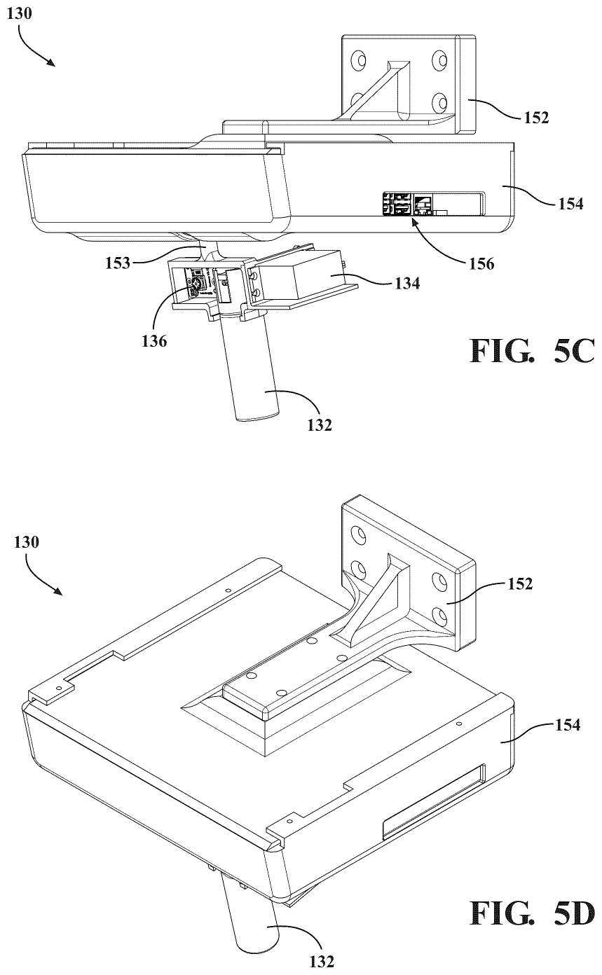

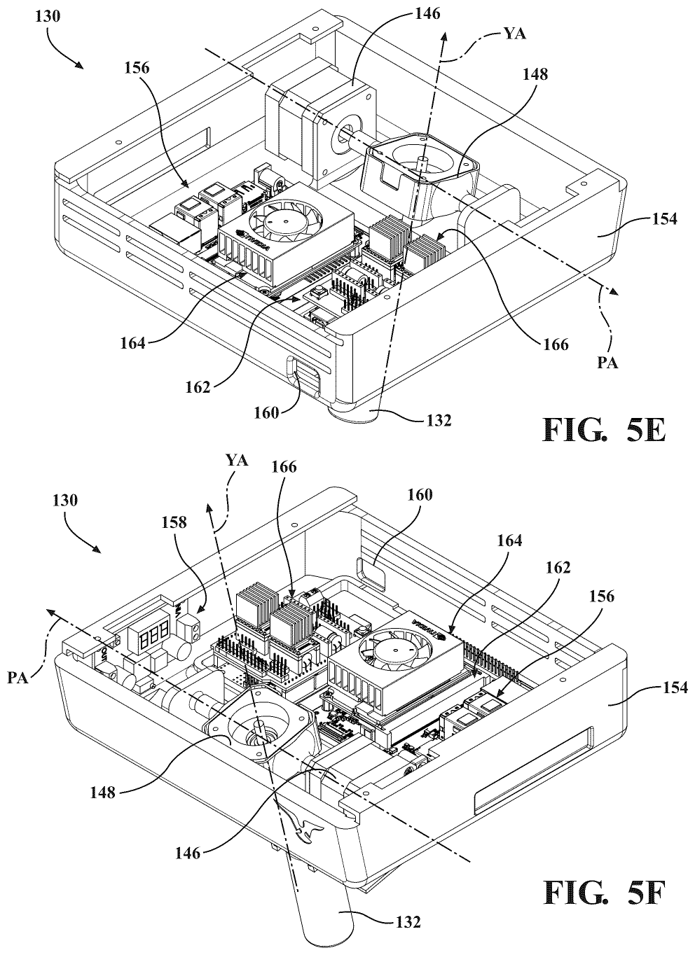

Referring to FIGS. 4A-5F, two implementation of a turret unit 130 are shown. First, looking to FIGS. 4A-4C, a first implementation of the turret unit 130 is shown in detail. In this implementation, the turret unit 130 includes a nonlethal device 132 for incapacitating/subduing the active assailant, a nonlethal actuator 134 for activating the nonlethal device 132, a camera 136 for tracking/identifying the active assailant, and a LIDAR unit 138 also for tracking/identifying the active assailant. The nonlethal device 132 may include a weapon that is intended to inflict temporary pain or discomfort unto an individual, such as a pepper spray dispenser, a pepperball gun, a rubber bullet gun, a bean bag gun, a taser, and a flashbang launcher. The LIDAR unit 138 may be a Terabee Distance Sensor Modules LiDAR ToF Range Find (TR-EVO-15M-12C), which has both depth perception and thermal imaging capabilities. The camera 136 and the LIDAR unit 138 are coupled to a first bracket 140, while the nonlethal device 132 and nonlethal actuator 134 are coupled to a second bracket 142. Both of the first and second brackets 140, 142 are coupled to a third bracket 144. In order to allow the turret unit 130 to aim the nonlethal device 132 and keep track of the active assailant using the camera 136 and/or the LIDAR unit 138, the turret unit 130 may include a first motor 146 and a second motor 148. In the illustrated implementation, the first motor 146 is housed within the first bracket 140 and allows the turret 130 to pivot about a pitch axis PA, while the second motor 148 is received by the third bracket 144 and permits the turret 130 to pivot about a yaw axis YA. Finally, the turret unit 130 may include a fourth bracket 150 arranged to house the second motor 148, and a fifth bracket 152 for coupling the turret unit 130 to a wall, a ceiling, a floor, or a traversal unit. Although not shown in FIGS. 4A-4C, the turret unit 130 may further include a unit computer as described below.

Second, focusing on FIGS. 5A-5F, a second implementation of the turret unit 130 is shown. Like the prior implementation, the turret 130 of FIGS. 5A-5F includes the nonlethal device 132, the nonlethal actuator 134, the camera 136, and the fifth bracket 152 for coupling the turret unit 130 to a wall, a ceiling, a floor, or a traversal unit. Although not shown, this implementation of the turret unit 130 may also include the LIDAR unit 138 disposed adjacent to the camera 136. Differently here, the turret unit 130 of FIGS. 5A-5F includes a housing 154 which surrounds most of the remaining components of the turret 130. This may be advantageous for scenarios where it is desired or necessary to conceal the response unit 102 from view of individuals in the environment in which the system 100 is disposed. For example, where the environment is a school, and it is not desirable for the unit 102 to be visible to children. The housing 154 may be coupled to the fifth bracket 152, while an arm 153 may extend down from the housing 154 and support the nonlethal device 132, the nonlethal actuator 134, and the camera 136.

As shown in FIGS. 5E and 5F, the housing 153 encloses the motors 146, 148, and the motors 146, 148 are each connected to the arm 153. Similar to the previous implementation, the first motor 146 allows the turret unit 130 to pivot the nonlethal device 132 and the camera 136 about the pitch axis PA, while the second motor 148 enables rotation about the yaw axis YA. Further, the housing 154 may surround an external input interface 156 and a power source 158. The external input interface 156 may include at least one USB port, HDMI port, ethernet port, or other input means for receiving data and communications from other devices. The power source 158 may include a battery (not shown), or may be configured to receive a power cord, such as through a port 160 defined by the housing 154. Even further, to control the various components, the turret unit 130 may include a unit computer 162, a targeting computer 164, and a actuator controller 166. The unit computer 162 may be connected to each of the external input interface 156, the power source 158, the targeting computer 164, and the controlling computer 166. This way, the unit computer 162 may receive power from the power source 158, pass power to each of the other computers 164, 166, receive data and communications from devices connected to the external input interface 156, and facilitate communication between each of the elements of the turret unit 130. While the unit computer 162 may be configured to control the overall operation of the turret unit 130, the targeting computer 164 may be in communication with the camera 136 (and/or the LIDAR unit 138 depending on the implementation) to provide means of tracking active assailants as further described below. The actuator controller 166, on the other hand, may be in communication with the motors 146, 148, and may cause the motors 146, 148 to pivot the turret unit 130 about the pitch and yaw axes PA, YA, such as in response to movement of the active assailant captured by the camera 136. In some implementations, the targeting computer 164 and the actuator controller 166 are implemented as part of the unit computer 162.

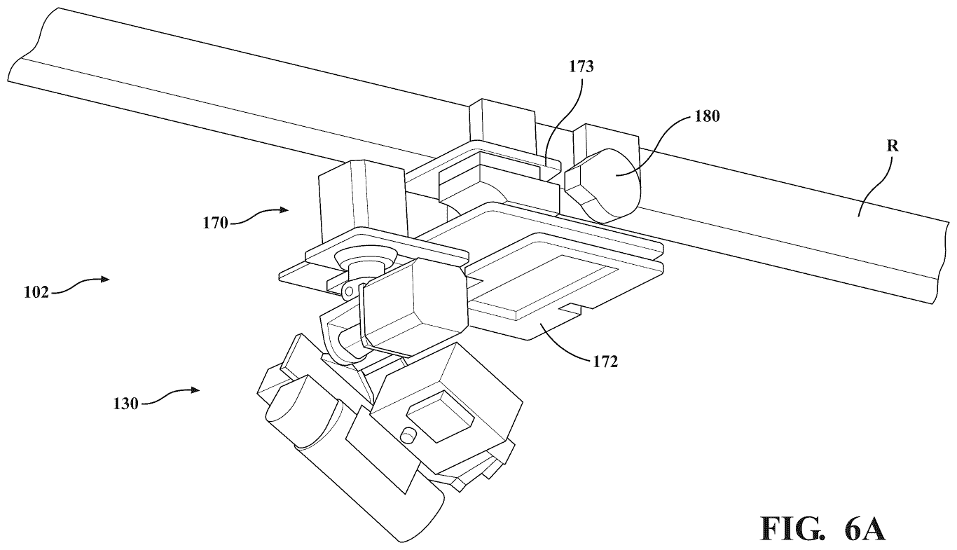

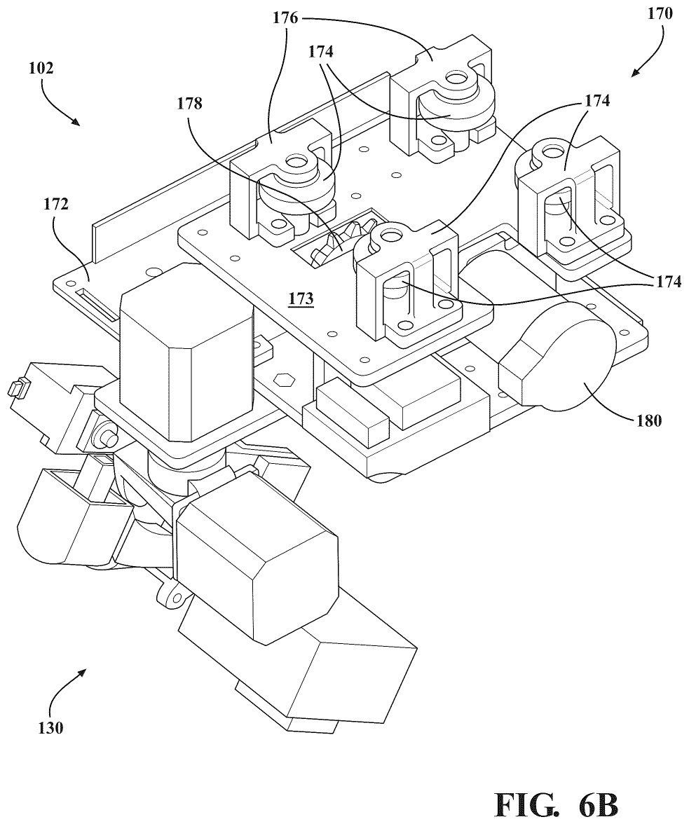

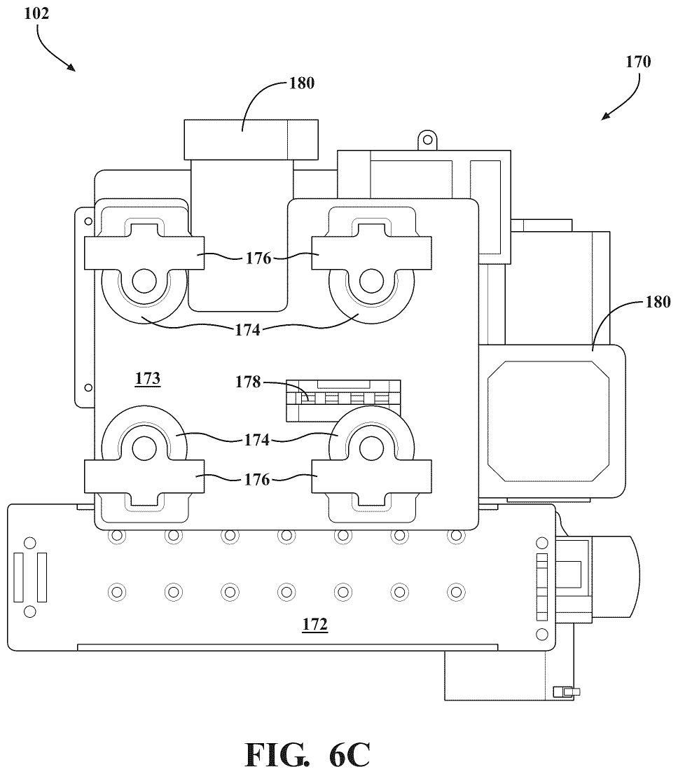

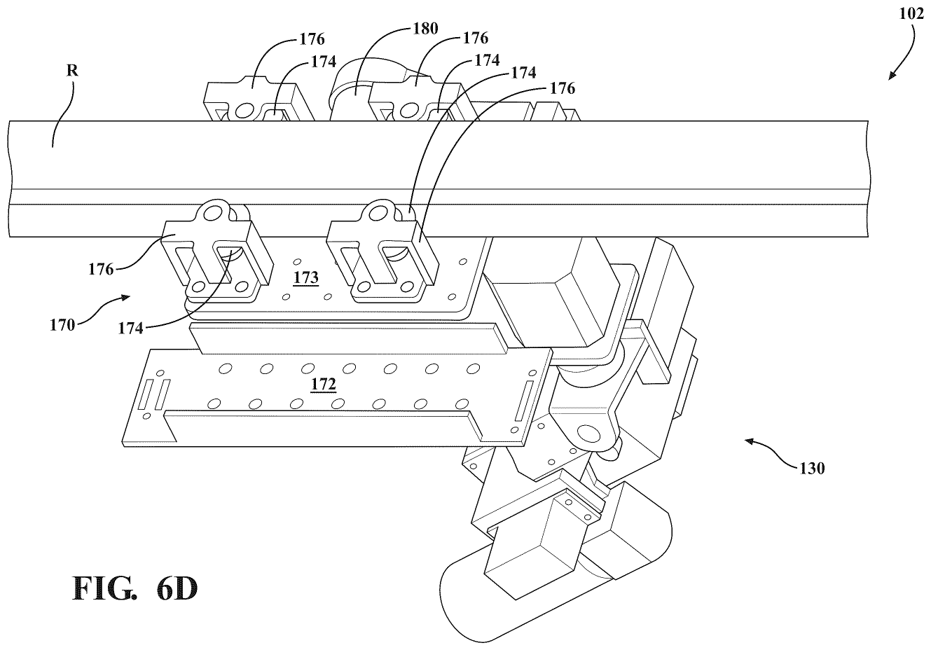

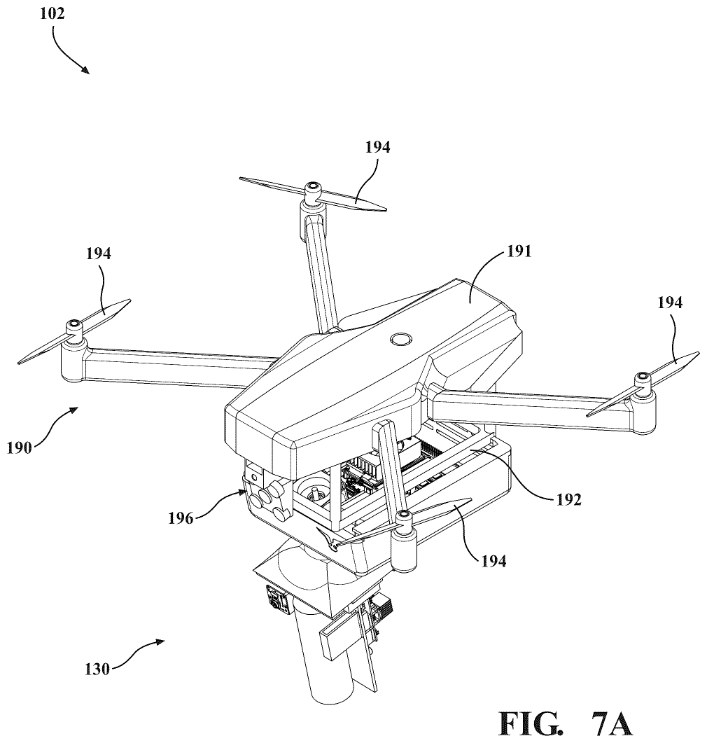

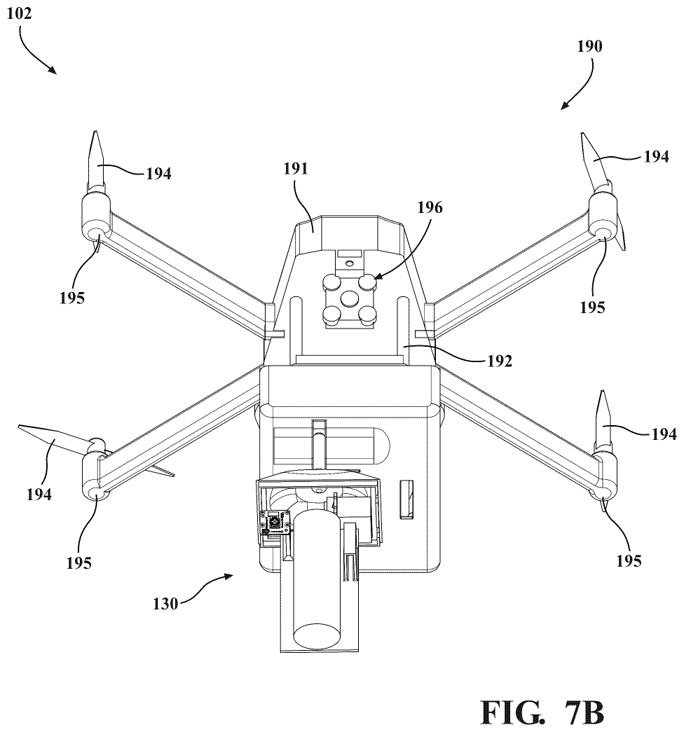

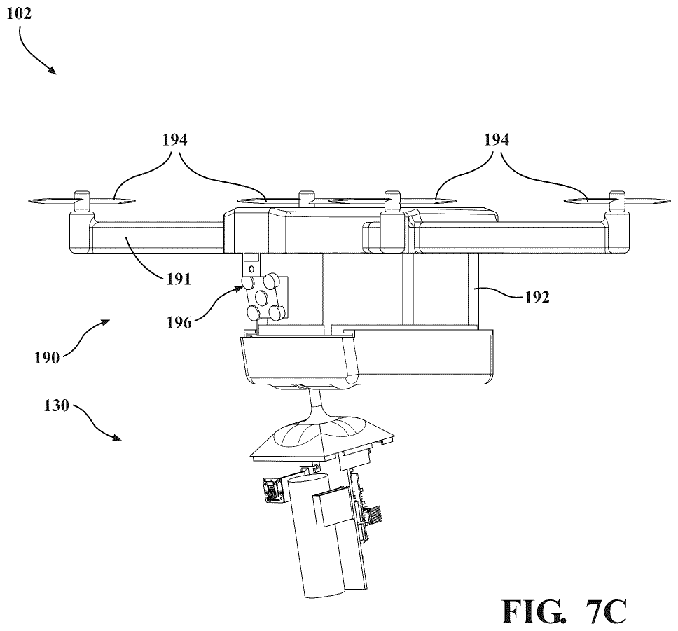

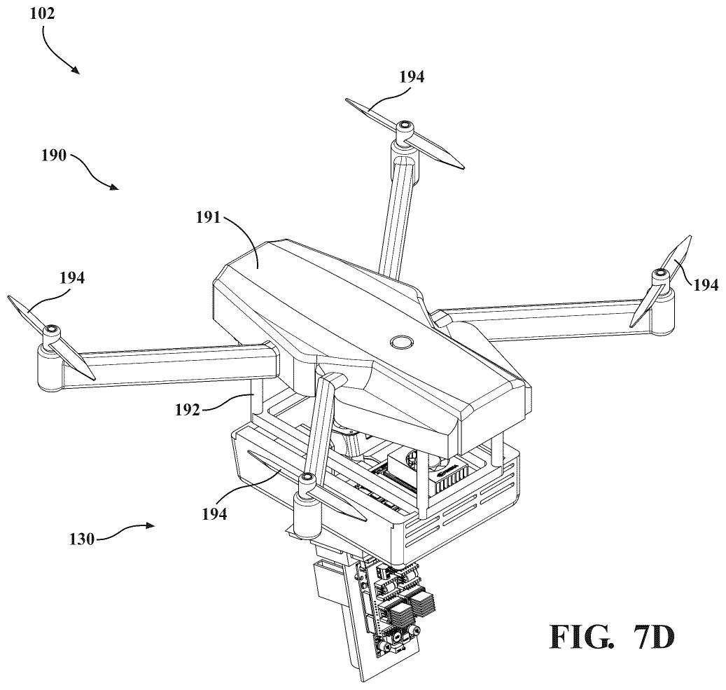

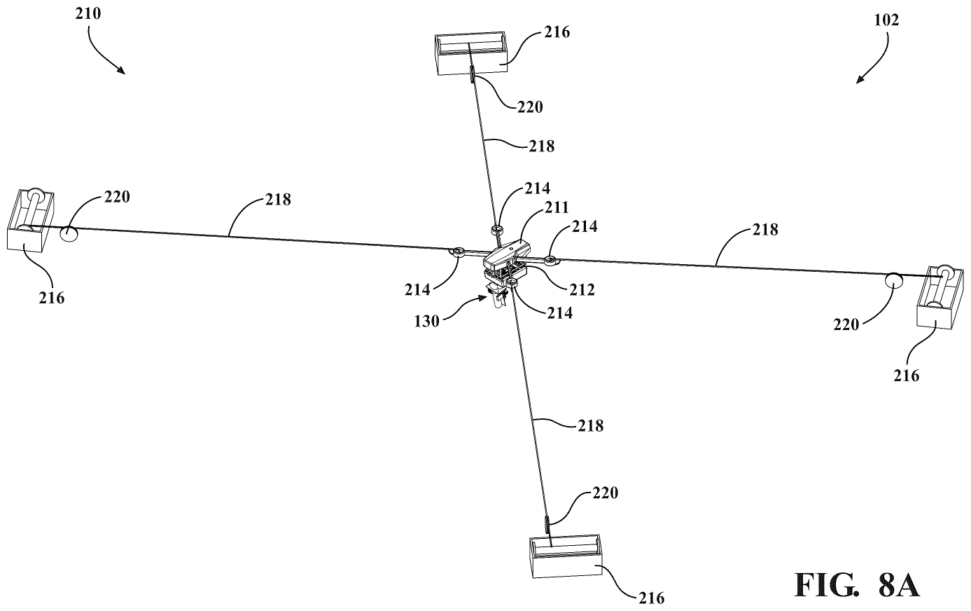

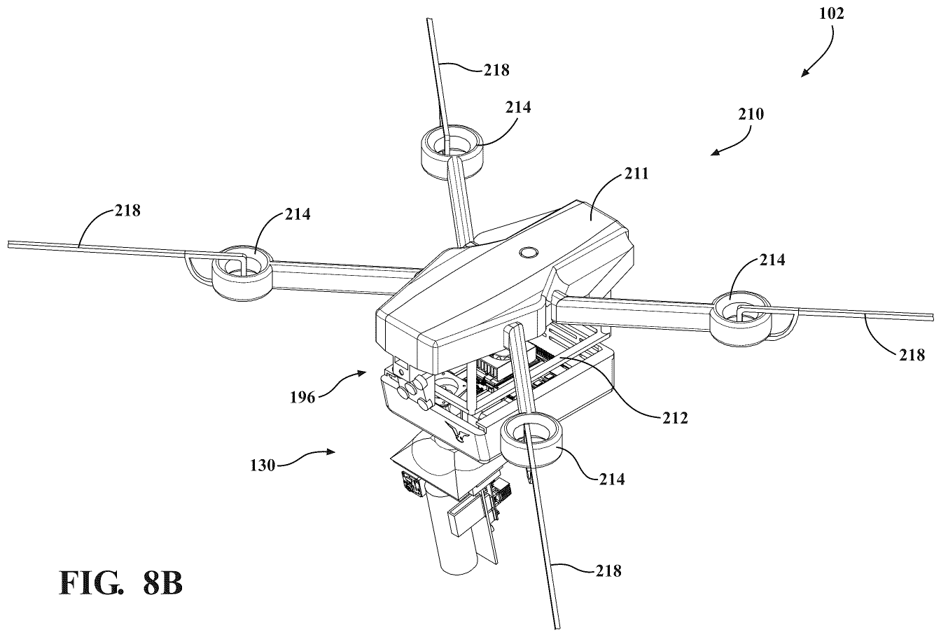

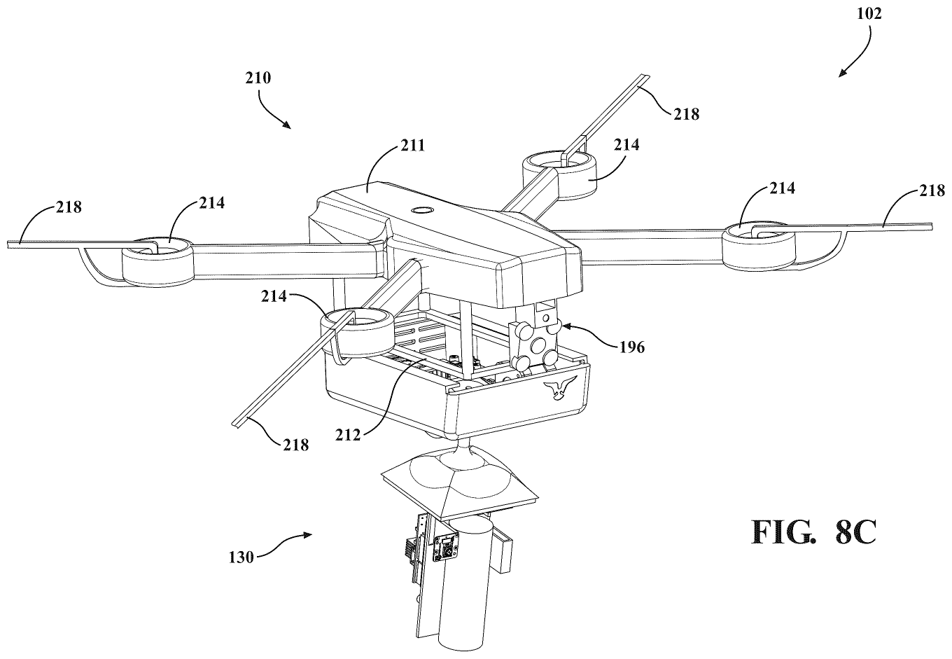

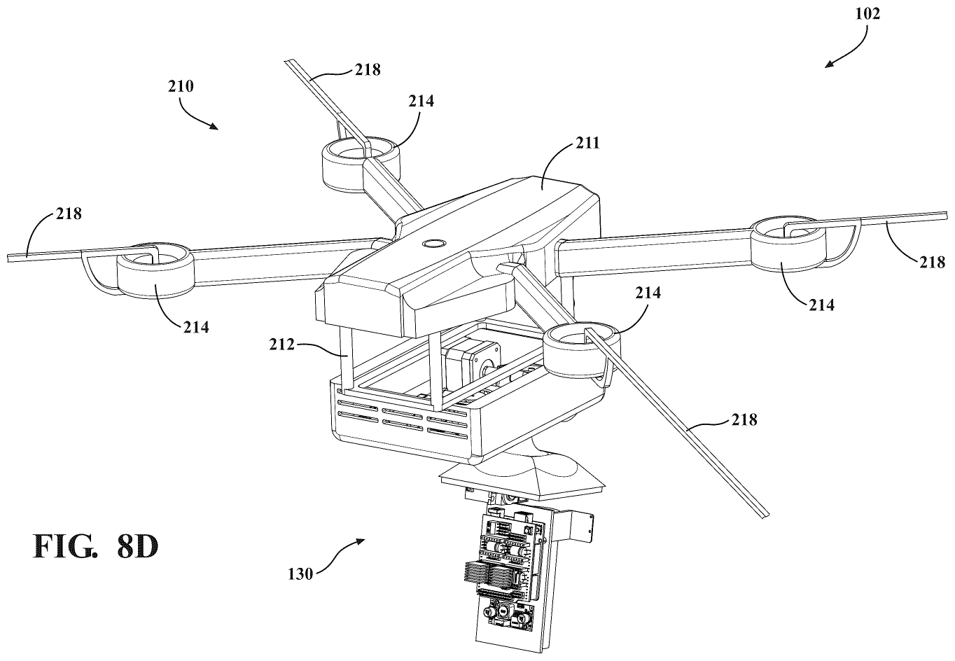

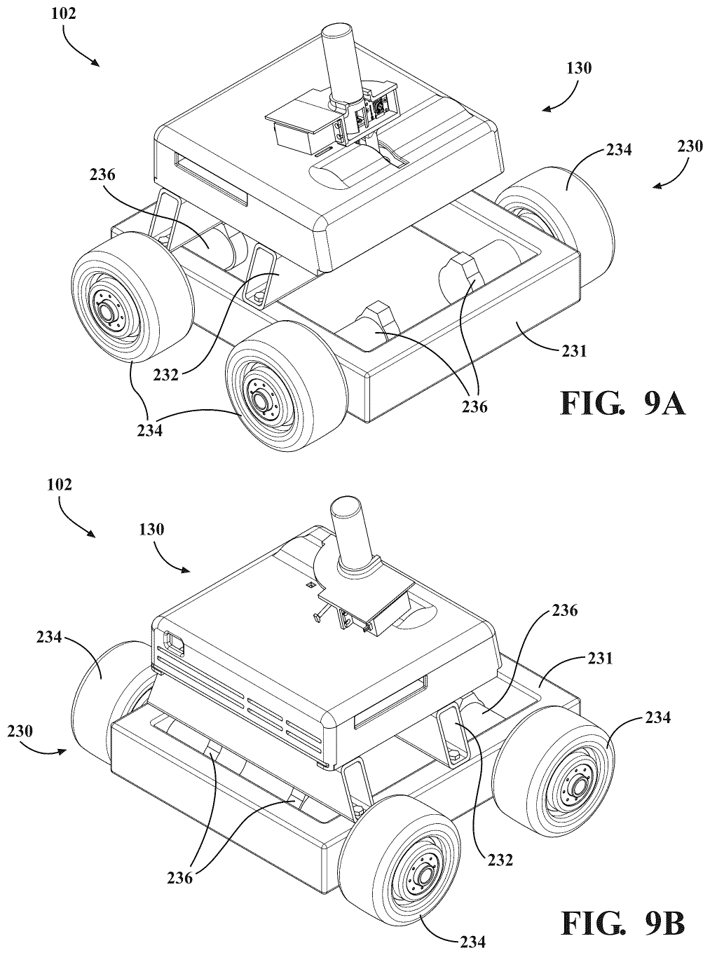

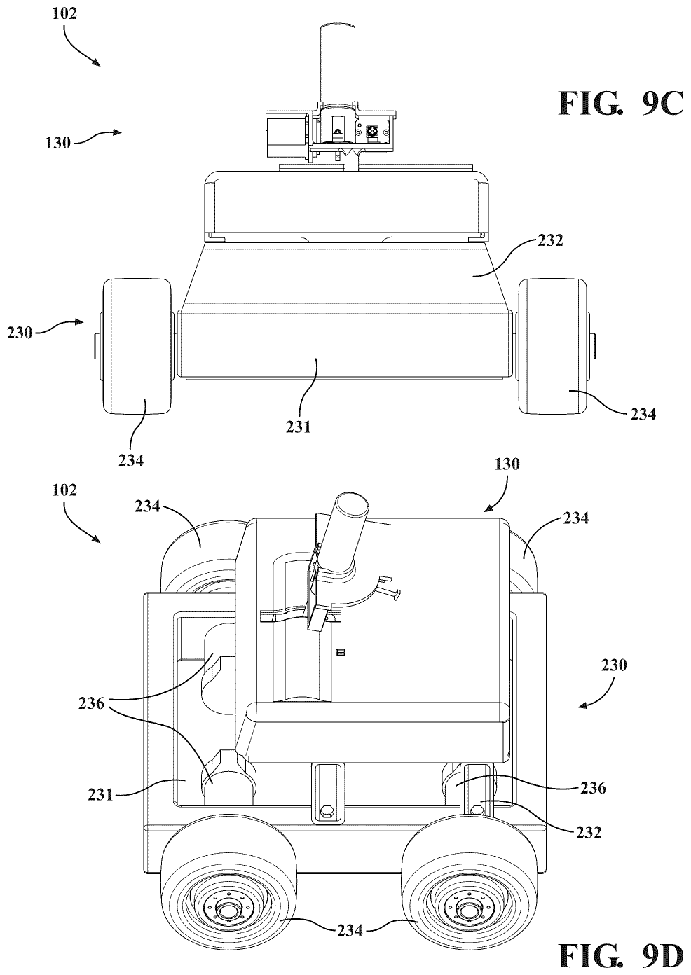

Referring to FIGS. 6A-9D, different forms of a traversal unit are illustrated. As briefly mentioned above, the response unit(s) 102 may include the turret unit 130 and, optionally, a traversal unit configured to move the turret unit 130 via rail, air, cable, or ground. To this end, a rail traversal unit 170 is shown in FIGS. 6A-6D, an aerial traversal unit 190 is shown in FIGS. 7A-7D, a cable traversal unit 210 is shown in FIGS. 8A-8D, and a wheeled traversal unit 230 is shown in FIGS. 9A-9D. As described above, each zone may include any number of response units 102 equipped with any type of traversal unit (or even coupled to a wall without a traversal unit). It is contemplated for the response unit(s) 102 to include either implementation of the turret unit 130 in combination with any type of traversal unit.

In FIGS. 6A-6D, an implementation of the response unit 102 equipped with the rail traversal unit 170 is shown. The rail traversal unit 170 is configured to move the response unit 102 (i.e., the turret unit 130) along a straight or curved rail R. The rail traversal unit 170 may include a first base plate 172 to which the turret unit 130 is coupled, a second base plate 173 coupled to the first base plate 173, a plurality of guide rollers 174 arranged to guide the response unit 102 along the rail R, a plurality of supports 176 coupled to the second base plate 173 and the guide rollers 174 to fix the position of the rollers 174 relative to the rest of the unit 102, a drive gear 178 configured to engage the rail R, and a drive motor 180 configured to drive the drive gear 178 in order to move the unit 102 along the rail R. Although not shown, the drive motor 180 may be connected to the actuator controller 166 and/or the unit computer 162 of the response unit 102 such that at least one of the computers 162, 166 may control movement of the unit 102.

In FIGS. 7A-7D, an implementation of the response unit 102 equipped with the aerial traversal unit 190 is shown. The aerial traversal unit 190 is configured to move the response unit 102 (i.e., the turret unit 130) through the air. The aerial traversal unit 190 includes a housing 191, a frame 192 coupled to the housing 191 and configured to fix the turret unit 130 to the housing 191, and a plurality of propellers 194 rotatably connected to the housing 191 and configured to generate lift. Although not shown, a power supply and a series of electric motors connected between the power supply and the propellers 194 may be included within the housing 191 for driving the propellers 194 and generating lift. In the illustrated implementation, the aerial traversal unit 190 further includes a secondary sensor package 196 for optically sensing the environment in ways similar to those described in reference to the camera 136 and the LIDAR unit 138 herein.

In FIGS. 8A-8D, an implementation of the response unit 102 equipped with the cable traversal unit 210 is shown. Similar to the aerial traversal unit 190, the cable traversal unit 210 is configured to move the response unit 102 (i.e., the turret unit 130) through the air. Further similar to the aerial traversal unit 190, the cable traversal unit 210 may include a housing 211, a frame 212 coupled to the housing 211 and configured to fix the turret unit 130 to the housing 211, and the secondary sensor package 196. Differently here, however, the cable traversal unit 210 includes a plurality of receiver rings 214 coupled to the housing 211. In order to move the cable traversal unit 210 through the air, the unit 210 further includes a plurality of base stations 216 that are meant to be attached to various walls (and/or the ceiling) of the environment in which the system 100 is disposed. Additionally, a plurality of cables 218 extending between each base station 216 and a corresponding receiver ring 214 are controlled by the base stations 216 to pull the cable traversal unit 210 through the air. In some implementations, a plurality of pulleys 220 may be coupled to the wall(s)/ceiling to guide at least a portion of the cables 218. Finally, although not shown, the cable traversal unit 210 may include electric motors disposed within the base stations 216 and configured to draw the cables 218 towards the base stations 216 to move the unit 210.

In FIGS. 9A-9D, an implementation of the response unit 102 equipped with the wheeled traversal unit 230 is shown. The wheeled traversal unit 230 is configured to move the response unit 102 (i.e., the turret unit 130) across the ground. The wheeled traversal unit 230 may include a housing 231 and a frame 232 coupled to the housing 231 and configured to fix the turret unit 130 to the housing 231. In order to move the unit 230, a plurality of wheels 234 rotatably connected to the housing 231 may be provided, each of the plurality of wheels 234 connected to one of a plurality of electric motors 236 disposed within the housing 231.

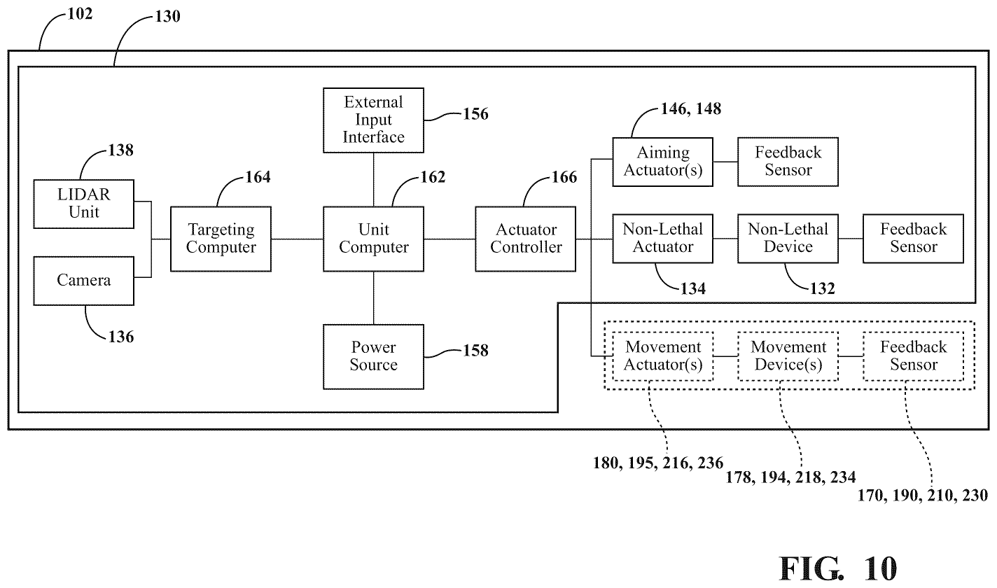

Regardless of implementation or traversal means provided, the response unit 102 communicates with, and is controlled by, the response computer 104 and/or the master computer 120. Further, the turret unit 130 of the response unit 102 is generally configured to communicate with the traversal unit 170, 190, 210, 230 coupled thereto. This way, the turret unit 130 may receive information from one or both of the computers 104, 120 and control the traversal unit 170, 190, 210, 230 in response to the received information and in order to move the response unit 102. This is described in more detail in reference to FIG. 10 below.

Referring to FIG. 10, a block diagram showing connections between components of the response unit 102 according to some implementations is shown. As shown, the response unit 102 includes the turret unit 130 and, optionally, one implementation of the traversal unit 170, 190, 210, 230. The turret unit 130 includes the unit computer 162, which may receive power from the power source 158, communicate with devices connected to the external input interface 156, and communicate with the targeting computer 164 to identify/track active assailants. More specifically, in response to signals received by the targeting computer 164, the unit computer 162 may then communicate with the actuator controller 166 to aim the unit 102 via the motors 146, 148, activate the nonlethal device 132 with the nonlethal actuator 134, and/or move the unit 102 by causing the movement actuators 180, 195, 216, 236 to drive the movement devices 178, 194, 218, 234. In some implementations of the response unit 102, the unit is mounted to a wall/ceiling and does not include the traversal unit 170, 190, 210, 230.

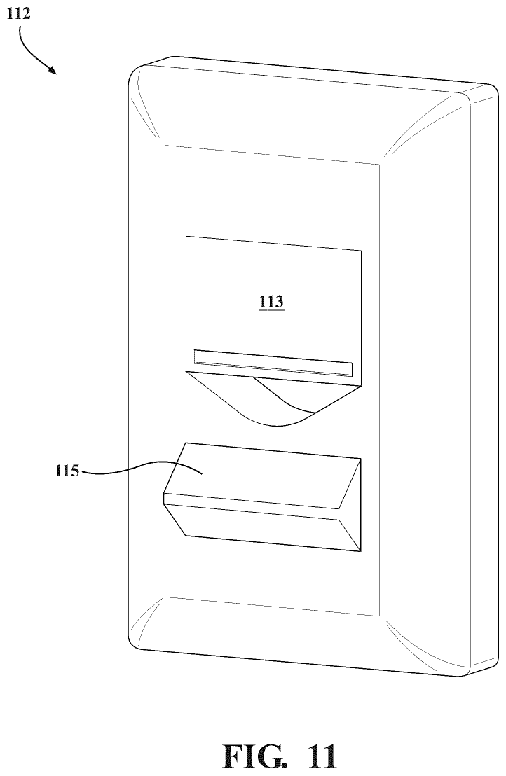

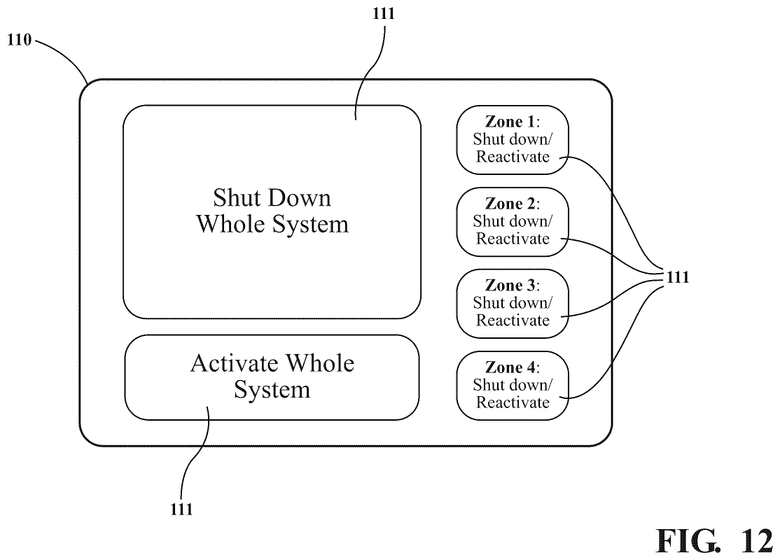

As briefly described above, the system 100 may be controlled by at least one of the physical switch 112 and/or input interface 108 configured to display the GUI 110. To this end, the physical switch 112 and the GUI 110 are shown in more detail in FIGS. 11 and 12.

First, looking to FIG. 11, the physical switch 112 may include a lever 113 or other suitable means of receiving an activation input from a user. Further, in some implementations, the physical switch 112 may include a scanning device 115 configured to authenticate the user prior to allowing activation of the system 100. The scanning device 115 may be configured to authenticate the user by scanning a code presented by the user, such as a barcode or QR code. In other implementations, the scanning device 115 may be an RFID reader configured to communicate with an RFID tag carried by the user. Second, referring to FIG. 12, the GUI 110 may display a plurality of buttons 111 that may be pressed by the user to control the system 100. Like the example described above, the input interface 108 may be a touch-enabled display, and the user may interact with the buttons 111 by engaging the touch-enabled display. The buttons 111 may activate/deactivate the system 100 as a whole or activate/deactivate specific zones of the system 100.

### II. Method Overview

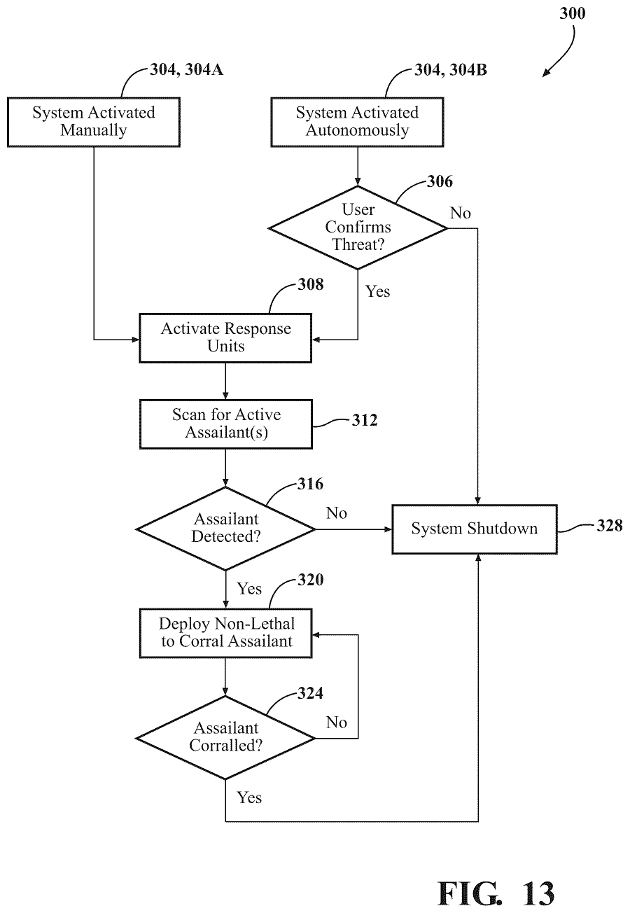

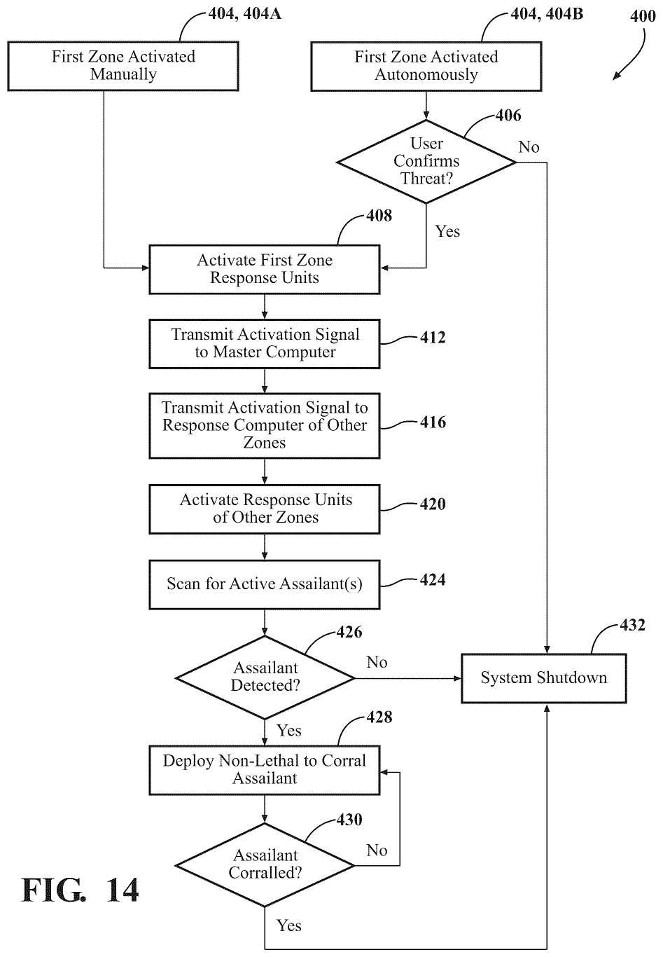

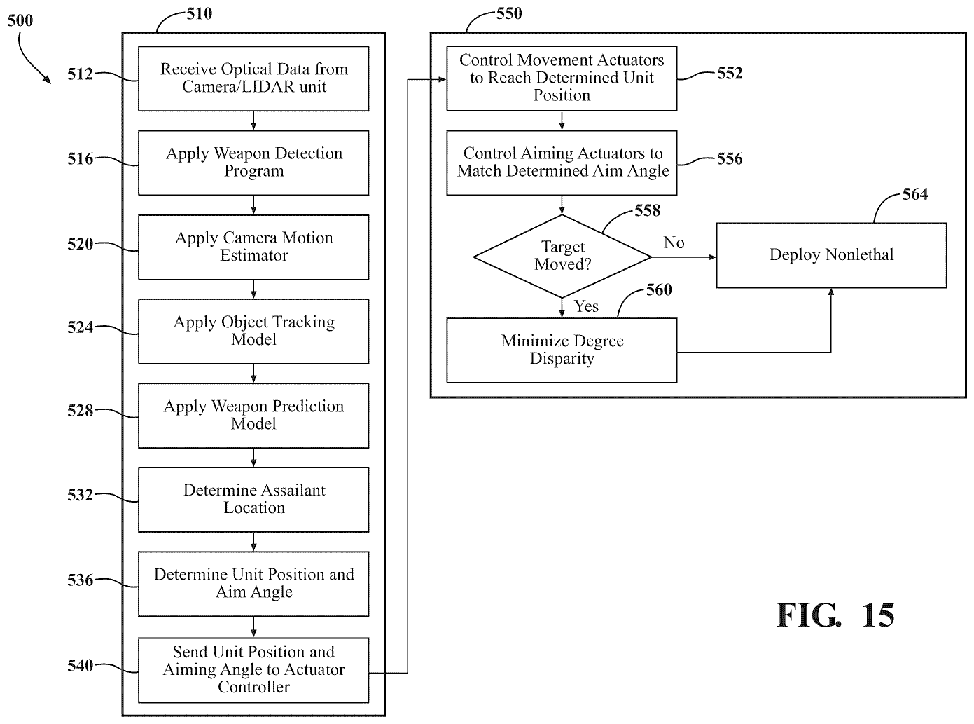

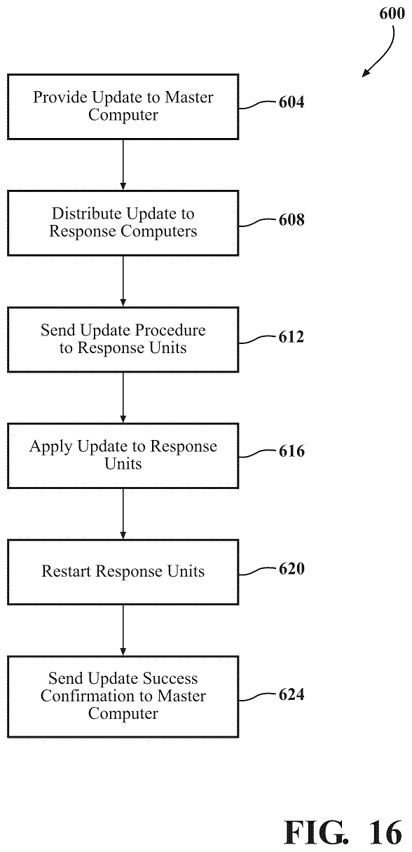

The active assailant response system 100 be controlled according to a number of methods as described herein. These methods are described in this section and in reference to FIGS. 13-16. Put simply, the methods may be carried out (e.g., by the system 100) in order to: (1) activate and control a single-zone implementation of the system 100 to corral an active assailant as shown in FIG. 13, (2) activate and control a multi-zone implementation of the system 100 to corral an active assailant as shown in FIG. 14, (3) identify and track an active assailant in order to deploy a nonlethal device towards the assailant as shown in FIG. 15, and (4) update the system 100 as shown in FIG. 16.

Referring to FIG. 13, a flowchart describing a method 300 of controlling a single-zone implementation of the active assailant response system 100 is shown. At 304, the system is activated. As shown, the system 100 may be activated manually at step 304A or autonomously at step 304B. If the system 100 is activated autonomously, such as in response to detection of an active assailant by one of the response units 102 and/or external detection unit 114, the method 300 may include determining if a user confirms the threat at 306. If step 306 is included and the user does not confirm the threat, the method 300 may jump to step 328 and the system 100 may shut down. Alternatively, the method may continue to step 308 if the system 100 was activated manually at step 304A, the user confirms the threat at step 306, or if the system 100 was activated autonomously at step 304B and step 306 is not included.

At 308, the response units 102 are activated and begin searching for the active assailant. For example, if the external detection unit 114 triggered activation of the system 100, the units 102 may attempt to move towards the external detection unit 114. As another example, if the system 100 was activated manually from the physical switch 112, the units 102 may attempt to move towards the switch 112. As the response units 102 move towards the potential location of the threat and/or once at least one of the units 102 to the potential location, the units 102 attempt to identify the threat at 312. This may include using one or both of the camera 136 and the LIDAR unit 138 to detect a weapon, such as according to the method described in reference to FIG. 15 below.

At 316, the system 100 determines if an active assailant was detected at 312. If not, the method 300 proceeds to step 328 and the system 100 shuts down. If the active assailant is detected, however, the method moves to step 320. Then, at 320, at least one of the units 102 deploy the nonlethal device 132 toward the active assailant. In some implementations, the system 100 is configured to use the units 102 to corral the assailant towards a predetermined location, such as outside the building in which the system 100 is disposed. As such, the method 300 may include determining if the assailant has been corralled at step 324. If the assailant has not been corralled, the method 300 returns to step 320, at which point the system 100 controls the units 102 to continue deploying the nonlethal device 132 toward the assailant to urge them toward the predetermined location. Once the assailant is determined to have been corralled at step 324, the method 300 moves to step 328 and the system 100 is shut down.

Referring to FIG. 14, a flowchart describing a method 400 of controlling a multi-zone implementation of the active assailant response system 100 is shown. Similar to the single-zone method 300, the multi-zone method 400 begins with system activation at step 404. If the system 100 is activated autonomously, such as in response to detection an active assailant by one of the response units 102 and/or external detection unit 114, the method 400 may include determining if a user confirms the threat at 406. If the threat is not confirmed at 406, the method 400 may move to step 432 and the system 100 may shut down. Instead, if the system 100 was activated manually at 404A, if the user confirms the threat at 406, or if the method 400 does not include step 406, the method 400 moves to step 408.

At 408, a first zone of the system 100, such as Zone 1, is activated by the corresponding response computer 104. The first zone corresponds to the zone in which the physical switch 112/GUI 110 that was used to manually activate the system 100 at 404A is located or in which the activate assailant was detected/confirmed at 404B and/or at 406. Assuming that Zone 1 is the first zone, the first response computer 104A transmits an activation signal to the master computer 120 at 412. In response, the master computer 120 transmits an activation signal to the response computers 104B, 104C associated with the other zones, such as Zone 2 and Zone 3.

Once activated, the response computers 104A, 104B, 104C activate their respective response units 102A, 102B, 102C at 420. The response units 102A, 102B, 102C then begin searching for the active assailant at 424, such as in ways similar to those described in reference to step 312 above. The method 400 continues to step 426, at which point the system 100 determines if the assailant can be detected. If not, the method 400 jumps to step 432 and the system 100 is shut down. If the active assailant is detected, however, the method moves to step 428. At 428, nonlethals 132 are deployed to corral the active assailant, such as towards a predetermined zone or out of the environment. Then, at 430, the system 100 determines if the assailant has been corralled into the predetermined zone or out of the environment. If not, the method returns to step 428. If the active assailant has been corralled, the method 400 moves to step 432 and the system 100 shuts down.

Further, in both of the methods 300, 400 described above, the response units 102 are tasked with locating/tracking the active assailant in order to deploy the nonlethal device 132 to corral/subdue the assailant. This occurs, for example, during steps 308 through 320 of the single-zone method 300 and/or steps 416 through 430 of the multi-zone method 400. To improve the capabilities of the response units 102 in locating/tracking the assailant, a machine learning algorithm may be used. The machine learning algorithm may assist the unit 102 in differentiating active assailants from potential victims, as well as determining when a person becomes an active assailant (e.g., by drawing a weapon).

Referring to FIG. 15, a flowchart describing a method 500 of controlling one of the response units using a targeting algorithm 510 and an actuator control algorithm 550 is shown. The method 500 is described as being carried out by one response unit 102, but the method 500 may be carried out by each response unit 102 of the system 100. Further, the method 500 is described as being carried by the unit computer 162, the targeting computer 164, and the actuator controller 166, but the method 500 may also be executed by the unit computer 162 alone.

Starting with the targeting algorithm 510, at 512, optical data is received by the targeting computer 164. The optical data may be generated by at least one of the camera 136 and the LIDAR unit 138. Subsequently, at 516, the targeting computer 164 may apply a weapon detection program to the optical data in order to detect weapons present in the optical data. The weapon detection program may be a machine learning algorithm, such as one trained on image/video data that depicts weapons. In one implementation, the weapon detection program is a trained version of the YOLOv8 algorithm released in 2023 by Ultralytics. The targeting computer 164 may require the weapon to be detected in at least three frames of optical data over a predetermined time period, such as one second, prior to confirming that a weapon has been detected at 516. Once a weapon is detected at 516, the method 500 moves to 520. At 520, a camera motion estimator is applied to the optical data to estimate a direction of movement of the weapon. With the weapon detected and its motion estimated, an object tracking model may be applied at 524 in order to keep track of the position of the weapon. This may include generating a bounding box around the weapon and/or associated active assailant, and overlaying the bounding box on the optical data so as to surround the weapon/assailant as they appear in the optical data.

Once the weapon is being tracked in the optical data, a weapon prediction model may be applied at 528. The weapon prediction model is configured to determine an expected relationship between the weapon and at least a portion of the body of the active assailant (e.g., the head of the assailant). In one case, this may include determining a type of the weapon, such as a pistol or a rifle, and determining an expected spatial relationship between a weapon of this type and the head of the assailant. In another case, this may include determining a pose of the weapon, such as an aiming pose or a cross-body pose, and determining an expected position of head of the assailant based on the pose of the weapon. Based on an output from the weapon prediction model, the location of the active assailant may be determined at 532. Then, at 536, a unit position and an aim angle of the response unit 102 may be calculated/determined at 536. The unit position and aim angle may correspond to those at which the unit 102 may deploy the nonlethal device 132 towards the active assailant, such as at the head of the active assailant. Further, the unit position may be determined according to how the active assailant should be corralled. For example, if the active assailant is in Zone 1, the unit position may be determined according to whether the active assailant should be corralled towards or away from Zone 1. The unit position and aim angle may be output to the actuator controller 166 at 540. The method 500 then continues to the actuator control algorithm 550.

Starting with step 552, the actuator control algorithm 550 begins by controlling the movement actuator 180, 195, 216, 236 to cause the movement device 178, 194, 218, 234 to move the response unit 102 to the unit position output by the targeting algorithm 510 at 540. At 556, the actuator controller 166 controls the aiming actuators 146, 148 to match the aim angle output by the targeting algorithm 510 at 540. The response unit 102 may determine if the target (e.g., the active assailant) has moved since step 540. If the target has not moved, the actuator controller 166 may cause the nonlethal actuator 134 to activate the nonlethal device 132 towards the active assailant. That said, if the target has moved since step 540, the actuator controller 166 may minimize any disparity between a current aim angle of the unit 102 and an updated aim angle of the unit 102 at 560. For example, in some implementations, the targeting algorithm 510 is continuously executed and periodically sends the updated aim angle to the actuator controller 166 during the method 500. Once the disparity is minimized, such as by changing the current aim angle to match the updated aim angle, the nonlethal device 132 is deployed at 564.

In some implementations, the active assailant response system 100 may be configured to be periodically updated. This may be advantageous where improvements to the various methods and algorithms 300, 400, 500, 510, 550 are desired after the system 100 has been installed in a building or other type of environment. This may be accomplished by sending the updates to the master computer 120 (and/or the response computer(s) 104. In addition to updating the operation of the master computer 120 and/or response computer 104, the individual response units 102 may also be updated.

In any of the methods 300, 400, 500 described above, the response units 102 may be controlled to corral the active assailant into/out of one of the zones and/or out of the environment. To this end and as briefly described above, the active assailant response system 100 may include a map of the environment (e.g., stored on at least one of the computers 104, 120). The map of the environment may include bounds of the environment, boundaries defining the various zones of the environment, locations of doors and walls, locations of natural barricades, positions of the units 102 within the environment, and/or other details about the environment. The system 100, such as the response computer(s) 104, 104A, 104B, 104C and/or the master computer 120, may thus determine how to instruct the response units 102 based on the map of the environment. Additionally, the system 100 may determine a corral position which corresponds to the position where the assailant should be corralled to. The corral position may include an entire zone, a specific position within the zone, or an area within the zone. The unit position may be determined based on the corral position and the map of the environment. Further, the system 100 may may be in communication with door mechanism of doors that separate the zones or parts of one zone, and system 100 may send a signal to the door mechanism to close and/or lock the door separating the first and second zones in response to the active assailant having been corralled into the corral position.

In one example, the system 100 may determine that the active assailant should be corralled towards or away from the first zone, and determine the unit position based on whether the active assailant should be corralled towards or away from the first zone. In this example, the system 100 may determine that the assailant should be corralled towards the first zone based on the map of the environment, as well as determine the unit position based on the map of the environment and the determination that the assailant should be corralled towards the first zone. In another example where the environment is smaller and includes a single zone, such as a convenience store, the system 100 determine that the assailant should be corralled against a corral position corresponding to a specific wall within the environment based on the map, and instruct the units 102 to move to unit positions that position the active assailant between the units 102 and the specific wall.

Referring to FIG. 16, a flowchart describing a method 600 of updating at least one of the response units 102 is shown. Starting at 604, the update may be provided to the master computer 120 in a multi-zone implementation of the system 100 or to the response computer 104 in a single-zone implementation of the system 100. If the system 100 is a single-zone implementation, the method 600 jumps to step 612. That said, if the system 100 is a multi-zone implementation, such as the implementation depicted in FIG. 3, the method 600 may continue to step 608 and distribute the update to the response computers 104. Then, at 612, an update procedure may be sent to the response units 102 (e.g., by one of the response and master computers 104, 120). The update procedure includes instructions that, when executed by the unit computer 162, prepare the units 102 to receive and apply the update. Once the units 102 have been prepared for the update, the update is applied to the units 102 at step 616. The units 102 may then restart at step 620, as well as send an update confirmation to the master computer 120 (e.g., via the corresponding response computer 104).

### III. Exemplary System Layouts

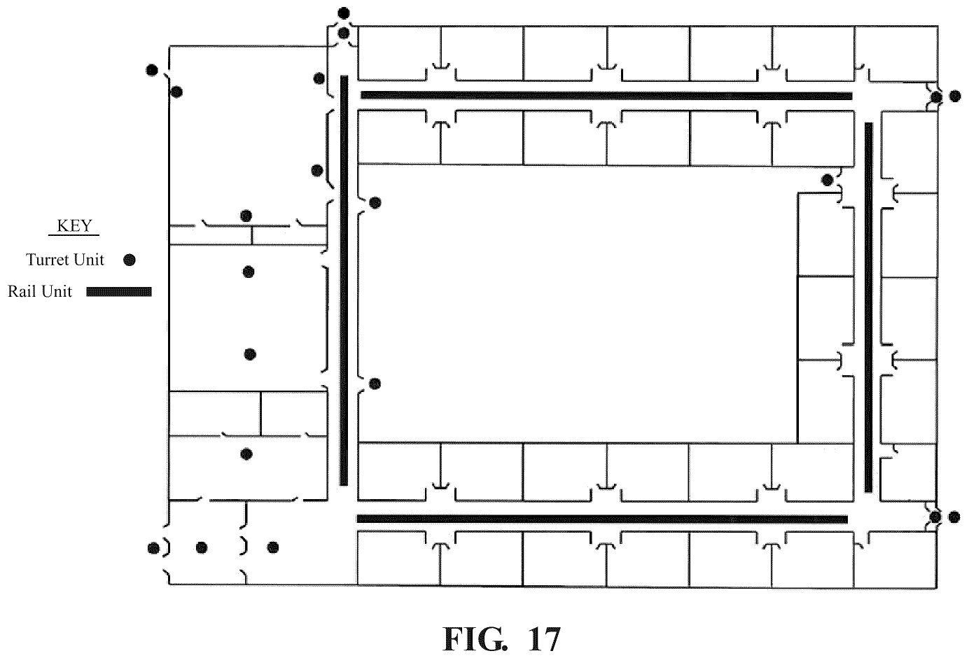

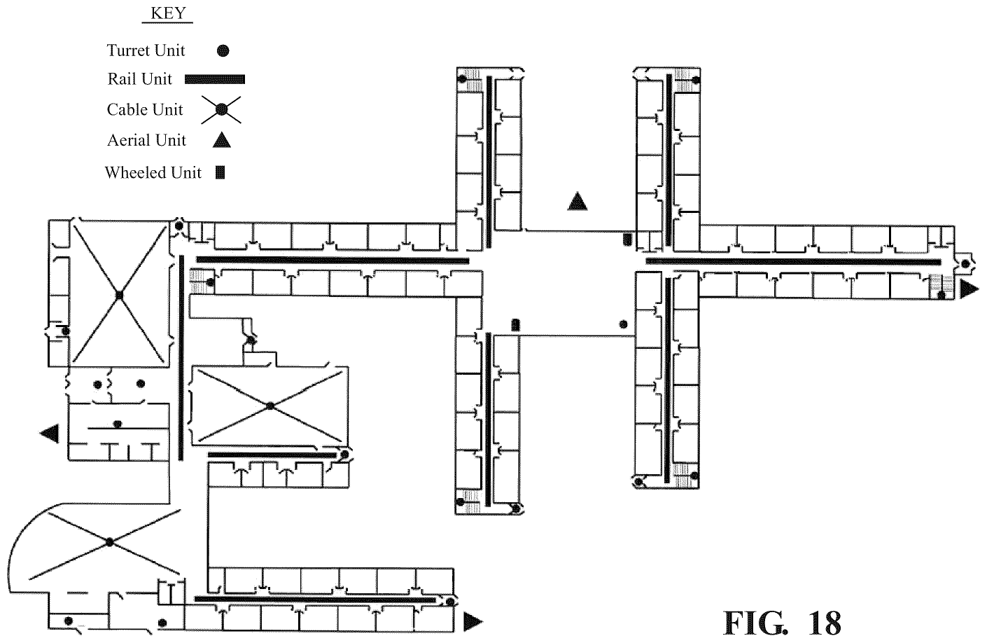

Many arrangements of the various components of the active assailant system 100 are contemplated. Since every such arrangement cannot be described herein, two exemplary arrangements of the system 100 are depicted in FIGS. 17 and 18.

Referring to FIG. 17, a first arrangement of response unit disposed in various zones of a small school is shown. As shown, response units 102 equipped with the rail traversal unit 170 are installed in hallways, and response units 102 including only the turret unit 130 are installed near each door/entryway.

Referring to FIG. 18, a second arrangement of response unit disposed in various zones of a large school is shown. Similar to the arrangement of the system 100 shown in FIG. 17, response units 102 equipped with the rail traversal unit 170 are install in the hallways, and turret unit 130 are installed near each door/entryway. Additionally here, response units 102 equipped with cable traversal units 210 are installed in large spaces that may include ground obstacles, such as gymnasiums and lunchrooms. For large open spaces that do not include ground obstacles, response units 102 equipped with the wheeled traversal unit 230 are installed therein. Finally, response units 102 having the aerial traversal unit 190 are disposed outside of the school.

Several embodiments have been discussed in the foregoing description. However, the implementations discussed herein are not intended to be exhaustive or limit the filter assembly to any particular form factor. The terminology which has been used is intended to be in the nature of words of description rather than of limitation. Many modifications and variations are possible in light of the above teachings and the system may be practiced otherwise than as specifically described.

What is claimed is:

1. An active assailant response system comprising:
a set of response units configured to deploy a nonlethal device, the set of response units including:
a first response unit arranged in a first zone of an environment, and
a second response unit arranged in a second zone of the environment;
a set of detection units configured to identify one or more active assailants within the environment, the set of detection units including:
a first detection unit arranged in the first zone of the environment, and
a second detection unit arranged in the second zone of the environment;
a computer in communication with the set of response units and the set of detection units, the computer being configured to:
determine that at least one active assailant is present within one of the first and second zones based on signals received from the set of detection units, and
activate the set of response units in response to the at least one active assailant being present within one of the first and second zones.

2. The active assailant response system of claim 1, wherein the first response unit includes the first detection unit and the second response unit includes the second detection unit.

3. The active assailant response system of claim 2, wherein the set of detection units further includes a third detection unit coupled to a wall of the environment, the wall being in one of the first and second zones of the environment.

4. The active assailant response system of claim 2, wherein at least one of the first and second response units includes a turret unit, the turret unit comprising:
a housing;
one of the first and second detection units, the one of the first and second detection units including at least one of a camera and a LIDAR unit coupled to the housing;
a nonlethal actuator coupled to the housing; and
a nonlethal device coupled by the housing and arranged in contact with the nonlethal actuator.

5. The active assailant response system of claim 4, wherein the nonlethal device includes at least one of a pepper spray dispenser, a pepperball gun, a rubber bullet gun, a bean bag gun, a taser, and a flashbang launcher.

6. The active assailant response system of claim 4, wherein the at least one of the first and second response units further includes a unit computer coupled to the housing, the unit computer configured to:
receive optical data from the at least one of the camera and the LIDAR unit;
identify an active assailant based on the optical data; and
activate the nonlethal actuator in response to the active assailant being identified.

7. The active assailant response system of claim 6, wherein the at least one of the first and second response units further includes at least one aiming actuator configure to pivot the response unit in at least one of a first and second degree of freedom, and the unit computer is configured to cause the at least one aiming actuator to keep the nonlethal device aimed at the active assailant.

8. The active assailant response system of claim 7, wherein the at least one of the first and second response units further includes a traversal unit configured to move the at least one of the first and second response units through the environment.

9. The active assailant response system of claim 8, wherein the traversal unit includes one of a rail traversal unit, an aerial traversal unit, a cable traversal unit, and a wheeled traversal unit.

10. The active assailant response system of claim 8, wherein the traversal unit is in communication with the unit computer, and the unit computer is further configured to:
determine a location of the active assailant;
determine a unit position corresponding to a position of the at least one of the first and second response units relative to the environment;
determine an aim angle corresponding to an angle between the at least one of the first and second response units and the active assailant at which the nonlethal device should be deployed;
cause the traversal unit to move the at least one of the first and second response units to the unit position;
cause the at least one aiming actuator to match a current angle of the nonlethal device to the aim angle; and
cause the nonlethal actuator to activate the nonlethal device in response to the at least one of the first and second response units being at the unit position and aiming towards the aim angle.

11. The active assailant response system of claim 10, where the unit computer is further configured to:
determine that the active assailant is present within the first zone;
determine that the active assailant should be corralled towards or away from the first zone; and
determine the unit position based on whether the active assailant should be corralled towards or away from the first zone.

12. The active assailant response system of claim 6, wherein the unit computer is configured to apply a machine learning algorithm to the optical data to identify the active assailant.

13. The active assailant response system of claim 1, further comprising at least one of a physical switch and a graphical user interface in communication with the computer and configured to activate the set of response units in response to input from a user.

14. The active assailant response system of claim 13, wherein the physical switch includes a scanning device configured to authenticate the user, and the computer is configured to deactivate the set of response units if the user is not authenticated.

15. The active assailant response system of claim 14, wherein the scanning device includes one of an RFID reader, a barcode scanner, and a QR code reader.

16. The active assailant response system of claim 1, wherein the computer is configured to:
activate the first response unit in response to the active assailant being present within the first zone of the environment; and
activate the second response unit in response to the active assailant being present within the second zone of the environment.

17. The active assailant response system of claim 1, wherein the computer is configured to:
determine that the active assailant should be corralled towards the first zone of the environment; and
instruct the set of response units to corral the active assailant towards the first zone of the environment.

18. The active assailant response system of claim 1, further comprising:
an external detection unit in communication with the computer and arranged in at least one of the first and second zones of the environment; and
an input interface in communication with the computer and arranged in the at least one of the first and second zones of the environment;
wherein the computer is configured to:
receive a signal from the input interface,
determine if the active assailant has been confirmed by a user based on the signal, and
deactivate the set of response units in response to the active assailant not being confirmed.

19. The active assailant response system of claim 1, further comprising:
a memory device in communication with the computer and having a map of the environment stored thereon, the map including boundaries defining the first and second zones of the environment;
wherein the computer is configured to cause the set of response units to corral the active assailant towards one of the first and second zones of the environment based on the map.

20. The active assailant response system of claim 19, wherein the computer is in communication with a door mechanism of a door separating the first and second zones, and the computer is configured to send a signal to the door mechanism to close and/or lock the door separating the first and second zones in response to the active assailant having been corralled into one of the first and second zones of the environment.

21. An active assailant response system comprising:
a response unit arranged in an environment, the response unit including:
a traversal unit configured to move the response unit about the environment,
a turret unit coupled to the traversal unit and configured to pivot about at least two degrees of freedom,
a nonlethal device supported by the turret unit, and
a detection unit supported by the turret unit configured to identify one or more active assailants within the environment;
a computer in communication with the response unit, the computer being configured to:
determine that at least one active assailant is present within the environment based on signals generated by the detection unit, and
activate the response unit in response to the at least one active assailant being present within the environment.

22. The active assailant response system of claim 21, wherein:
the system further comprises a memory unit in communication with the computer and having a map of the environment stored thereon; and
the computer is further configured to:
determine a corral position to which the active assailant should be corralled,
determine a unit position based on the corral position and the map of the environment, and
cause the response unit 102 to move to the unit position in order to corral the active assailant.

23. The active assailant response system of claim 22, wherein the computer is configured to:
determine a position of the active assailant, and
determine the unit position such that the position of the active assailant is between the unit position and the corral position.

24. The active assailant response system of claim 21, wherein the computer is in communication with a door mechanism of a door within the environment, and the computer is configured to send a signal to the door mechanism to close and/or lock the door in response to the active assailant having been corralled into the corral position.

25. The active assailant response system of claim 21, further comprising an external detection device coupled to a wall of the environment.

26. The active assailant response system of claim 21, wherein the nonlethal device includes at least one of a pepper spray dispenser, a pepperball gun, a rubber bullet gun, a bean bag gun, a taser, and a flashbang launcher.

27. The active assailant response system of claim 21, wherein the turret unit comprises:
a housing;
at least one aiming actuator configured to pivot the turret unit about the at least two degrees of freedom; and
a nonlethal actuator coupled to the housing and configured to activate the nonlethal device.

28. The active assailant response system of claim 27, wherein the at least one of the first and second response units further includes a unit computer coupled to the housing, the unit computer configured to:
receive optical data from the detection unit;
identify an active assailant based on the optical data; and
activate the nonlethal actuator in response to the active assailant being identified.

29. The active assailant response system of claim 28, wherein the unit computer is configured to cause the at least one aiming actuator to keep the nonlethal device aimed at the active assailant.

30. The active assailant response system of claim 21, wherein the traversal unit includes one of a rail traversal unit, an aerial traversal unit, a cable traversal unit, and a wheeled traversal unit.

31. The active assailant response system of claim 30, wherein the traversal unit is in communication with the unit computer, and the unit computer is further configured to:
determine a location of the active assailant;
determine a unit position corresponding to a position of the at least one of the first and second response units relative to the environment;
determine an aim angle corresponding to an angle between the at least one of the first and second response units and the active assailant at which the nonlethal device should be deployed;
cause the traversal unit to move the at least one of the first and second response units to the unit position;
cause the at least one aiming actuator to match a current angle of the nonlethal device to the aim angle; and
cause the nonlethal actuator to activate the nonlethal device in response to the at least one of the first and second response units being at the unit position and aiming towards the aim angle.

32. The active assailant response system of claim 31, wherein the unit computer is configured to apply a machine learning algorithm to the optical data to identify the active assailant.

33. The active assailant response system of claim 21, further comprising at least one of a physical switch and a graphical user interface in communication with the computer and configured to activate the response unit in response to input from a user.

34. The active assailant response system of claim 33, wherein the physical switch includes a scanning device configured to authenticate the user, and the computer is configured to deactivate the response unit if the user is not authenticated.

35. The active assailant response system of claim 34, wherein the scanning device includes one of an RFID reader, a barcode scanner, and a QR code reader.

36. The active assailant response system of claim 21, further comprising:
an external detection unit in communication with the computer and arranged in the environment; and
an input interface in communication with the computer and arranged in the at least one of the first and second zones of the environment;
wherein the computer is configured to:
receive a signal from the input interface,
determine if the active assailant has been confirmed by a user based on the signal, and
deactivate the set of response units in response to the active assailant not being confirmed.
